(19) United States
(12) Patent Application Publication
(10) Pub. No.: US 2020/0318933 A1
(43) Pub. Date: Oct. 8, 2020

(54) BULLET-PROOF ELECTRICAL DEVICE

(71) Applicant: SIEMENS AKTIENGESELLSCHAFT, MUENCHEN (DE)

(72) Inventor: HANNES MARBLER, WEIZ (AT)

(21) Appl. No.: 16/652,701

(22) PCT Filed: Sep. 28, 2018
(86) PCT No.: PCT/EP2018/076479

§ 371 Date: Apr. 1, 2020

(30) Foreign Application Priority Data
Oct. 18, 2017 (DE) 10 2017 218 624.0

(51) Int. Cl. F41H 5/22; F41H 5/24; H01F 27/02; H01F 27/40

(52) U.S. Cl. CPC F41H 5/22; F41H 5/24; H01F 27/10; H01F 27/402; H01F 27/02

(57) ABSTRACT

An electrical device for connection to a high-voltage electrical system includes a fluid-tight tank which is filled with an insulating fluid, an active element which is disposed in the tank and has a magnetizable core and at least one winding which surrounds a core section, and a bullet-resistant armor which sheaths the tank and forms a mounting opening. In order to allow easy access, which can be matched to respective requirements, for servicing and mounting purposes, the mounting opening can be closed by a bullet-resistant cover which can be displaced parallel to the armor.

The invention relates to an electrical device for connection to a high-voltage electrical system with a fluid-tight tank, which is filled with an insulating fluid, an active element arranged in the tank, which has a magnetizable core and at least one winding enclosing a core section, and bullet-resistant armor enveloping the tank, which forms a mounting opening.

Such an electrical device is already known from WO 2016/041566 A1. There a transformer is revealed that has a fluid-tight tank filled with insulating liquid. A magnetizable core with three core legs is arranged in the tank, wherein each leg is surrounded by concentrically arranged windings. In order to protect the transformer from destructive attacks by firearms or explosives, the transformer is equipped with an armor made of steel with a tensile strength Rₘ of over 1000 MPA. The armor consists, for example, of overlapping vertical panels that surround the transformer tank in a fence-like manner. One panel is attached to another panel by means of a hinge, so that the panels can be pivoted. In this way, a mounting opening is provided in the armor fence, which allows access to components of the transformer for maintenance purposes.

The previously known electrical device has the disadvantage that the mounting opening is difficult to open by hand alone. Moreover, the mounting opening, which is limited in size to the panel width, is often not sufficient to provide sufficient and convenient access to the components of the electrical device behind the armor. In particular, the size of the assembly cannot be adapted to the prevailing requirements.

The object of the invention is therefore to provide an electrical device of the type mentioned above, which provides convenient access for maintenance and assembly purposes that can be adapted to the specific requirements.

The invention achieves this object in that the mounting opening can be closed by means of a movable bullet-resistant cover that can be displaced parallel to the armor.

According to the invention, an electrical device is provided, which provides a movable and at the same time bullet-resistant cover. With the help of the bullet-resistant cover, the mounting opening, which is provided in the armor, can be easily closed by hand. Moreover, the size of the mounting opening is decoupled from the width of the panels. In other words, the position and size of the mounting opening can be adjusted to the respective requirements. On the one hand, the adjustment concerns the dimensions, i.e. the size of the mounting opening. If the armor is designed as an armor fence that encloses the tank at a distance, the mounting opening can be designed to be so large that the component behind the armor fence can be conveniently accessed through the mounting opening. This adjustment is also possible in terms of its location and in particular the height of the mounting opening measured from the assembly point. A faulty component can therefore be quickly and conveniently serviced or replaced, for example.

The electrical plant according to the invention is for example a transformer, a choke or a switching device that is provided for connection to a high-voltage electrical system. The high-voltage electrical system is, for example, a high-voltage transmission network with voltages above 50 kV or a medium-voltage electrical system, also known as the power distribution network, whose voltages are between 50 kV and 1 kV. Such an electrical system is usually a node in the respective high-voltage electrical system, which can be a potential target for external attacks in times of crisis. Such an attack is, for example, the firing of a handgun or an explosion triggered by an explosive device near the electrical device.

The armor according to the invention—like the cover—advantageously consists of a steel with a tensile strength Rm of more than 1000 MPA or other materials with a corresponding tensile strength. A steel with the above properties is also referred to as armored steel.

Appropriately, the cover is retained by a retaining rail. The mounting rail is used on the one hand to support but also to guide the cover in a displacement direction, which advantageously runs essentially parallel to the surface of the armor of the electrical device according to the invention.

Advantageously, the retaining rail is attached to the tank. The tank provides the necessary mechanical strength for the bullet-resistant cover, which is usually of a heavy weight.

It is particularly advantageous if the cover has track rollers that are supported in the retaining rail. The track rollers allow a particularly easy movement of the cover in the retaining rail and thus particularly easy access to the components of the electrical device. Instead of track rollers, however, other types of support may be considered in the context of the invention, which allow simple sliding of the cover in the retaining rail.

It brings further advantages if the cover has guide rollers, which are supported in a guide rail. According to this embodiment of the invention, a guide rail is provided that simplifies the opening and closing of the cover still more, especially if the cover is large and heavy. Thus, for example, with a smaller cover with a length and width each of less than 1 meter, only one retaining rail may be sufficient. For larger covers, however, it is advantageous if an additional guide rail is provided.

The guide rail is advantageously arranged below the retaining rail.

The guide rail can also be attached to the tank in the context of the invention.

According to an advantageous embodiment, however, the guide rail is attached to a pipeline of the electrical device. Transformers, chokes or the like often have pipeline systems installed outside the tank. Since the guide rail does not have to bear the entire weight of the cover but is only used to support the sliding or rolling when moving the cover door, the guide rail can also be simply attached to on the outer pipeline system for cost and space reasons. For this purpose, for example, support pins of the guide rail are welded to the pipeline system or mechanically fixed in other ways.

In a further embodiment of the invention, the armor can at least partially form a wall of the tank. The armor does not therefore have to be completely formed as a fence-like structure that surrounds the outer wall of the tank at a distance. Rather, the wall of the tank itself can be the armor. The cover is then conveniently provided with a sealant to provide a fluid-tight tank when the mounting opening is closed by the cover.

Other expedient embodiments and advantages of the invention are the subject matter of the following description of exemplary embodiments of the invention with reference to the figures of the drawing, wherein identical components are provided with the same reference characters and wherein

FIG. 1 shows an exemplary embodiment of an electrical device according to the prior art,

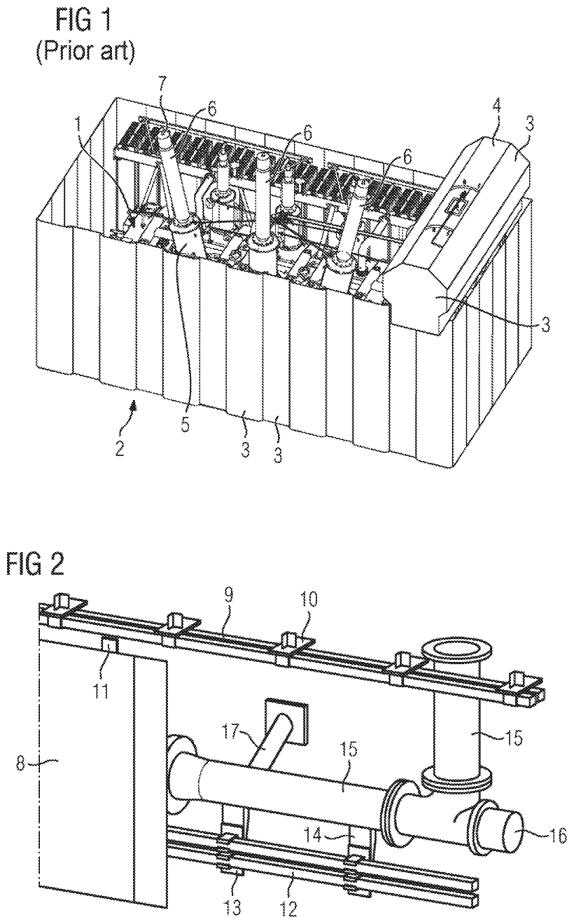

FIG. 2 shows an embodiment of a cover with retaining and guide rails of an electrical system according to the invention

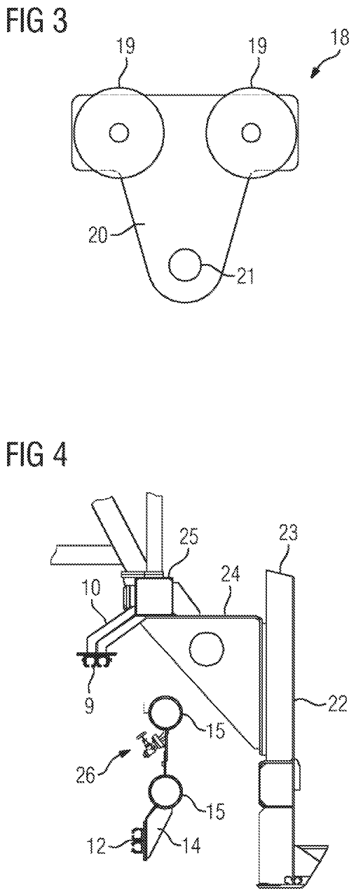

FIG. 3 shows an embodiment of track rollers of the cover according to FIG. 2 and the

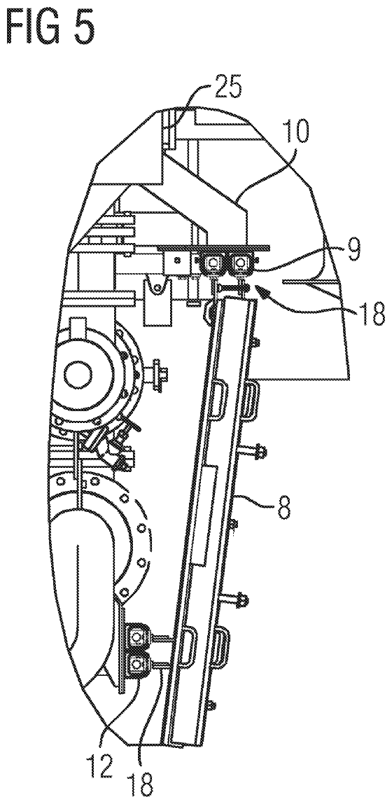

FIGS. 4 and 5 show the fastening of the cover by way of example and schematically.

FIG. 1 shows in a perspective view a bullet-proof electrical device known from the prior art, which is implemented there as a transformer 1. The transformer 1 is resting on a base that is not shown in more detail. A bullet-resistant armor 2 or armor plate envelops the transformer 1, especially the tank thereof which is not shown in detail in FIG. 1. The armor 2 is constructed in terms of its nature and dimensions so that it will withstand a bullet or a fragmentation threat emanating from the surrounding terrain, so that all components of the electrical device 1 are protected by the armor 2.

In the example shown in FIG. 1, the armor 2 consists of individual panels 3, which extend vertically or perpendicularly upwards from the ground. Each panel 3 is made of a steel sheet with a tensile strength above 1000 MPA. The sheet thickness depends on the desired rating (UL752) or the required test level (VPAM APR 2006). Above the transformer 1, an expansion vessel 4 can be seen, which is also enclosed by panels 3, so that the required protection is provided. The transformer 1 forms a dome 5 at its top, into which high voltage feedthroughs 6 are introduced. Each high-voltage feedthrough 6 has an outdoor connection 7, which is used to connect a high-voltage line of an energy supply network. The domes 5 are connected to the oil chamber, i.e. the tank interior, of the transformer 1. Each feedthrough 6 is thus arranged on the insertion-side in said oil chamber and connected to a winding in each case.

FIG. 2 shows an exemplary embodiment of a cover 8, which substantially corresponds to an electrical device 1 according to the invention, such as the electrical device shown in FIG. 1. According to the invention however, the electrical device 1 has a mounting opening, the size of which is somewhat smaller than the size of the cover 8. In this way it is ensured that the mounting opening can be completely protected by the cover 8. The cover thus extends to the full extent beyond the mounting opening, which is not shown in the figure.

The cover 8 preferably consists of the same material as the armor 2 of the electrical device 1 according to the invention. For holding the cover 8, a retaining rail 9 is provided, which is attached to the transformer tank via fastening means 10. The cover 8 has retaining elements 11, which can be equipped with track rollers, which will be discussed in more detail below. The cover 8 is supported in the retaining rail 9 by means of the track rollers and the retaining elements 11 and can be moved in the longitudinal direction of the retaining rail 9.

A guide rail 12 can be seen below the retaining rail 9, wherein the cover is also supported in the guide rail. The fastening means 10 are made, for example, of pieces of precious sheet metal. The supporting of the cover 8 in the guide rail 12 can also be carried out by means of rollers or other means, which allow a simple movement in the longitudinal direction of the guide rail 12. Here it is self-evident that the retaining rail 9 and the guide rail 12 are aligned parallel to each other.

In contrast to the retaining rail 9, the guide rail 12 is not directly attached to the tank of the electrical device. Rather, the guide rail 12 is equipped with angle mountings 13, which are attached to a pipeline 15 of the electrical device by retaining arms 14. The pipeline 15 has a pump 16, which is provided for circulating the insulating fluid arranged in the transformer tank. In this case, the pipeline 15 is mounted on the tank of the electrical device 1 by fastening bolts 17.

FIG. 3 shows an exemplary embodiment of the track rollers 18 in a side view. It can be seen that each track roller 18 has two rollers 19 that are rotatably installed in an attachment section 20, wherein a mounting opening 21 for connection to the retaining element 11 of the cover 8 is formed in the attachment section below the rollers 19.

FIG. 4 shows schematically and by way of example the attachment to the wall 22 of the tank of the transformer, wherein the wall forms strengthening ribs 23. An angle mounting 24 is attached to the strengthening rib 23 shown, which holds a cross member 25 on its side facing away from the strengthening rib 23. The cross member 25 extends at a distance from and parallel to tanks consisting of the enveloping strengthening ribs 23 and wall 22.

In the illustration shown in FIG. 5 it can be seen that the fastening means 10 extend from the retaining rail 9 to the cross member 25, on which they are mechanically fixedly mounted, for example by welding. The retaining rail 9 is thus fixedly connected via the fastening means 10, the cross member 25 and the angle mounting 24 to the tank consisting of strengthening rib 23 and side wall 22. Moreover, it can be seen that the cover 8 is supported in the guide rail by means of track rollers 18.

The pipeline 15 is equipped with a shut-off device 28 in the exemplary embodiment shown.

1-9. (canceled)

10. An electrical device for connection to a high-voltage electrical system, the electrical device comprising:
a fluid-tight tank to be filled with an insulating fluid;
an active element disposed in said tank, said active element having a magnetizable core and at least one winding enclosing a section of said core;
a bullet-resistant armor enclosing said tank and forming a mounting opening; and
a bullet-resistant cover being movable parallel to said armor for locking said mounting opening.

11. The electrical device according to claim 10, which further comprises a retaining rail holding said cover.

12. The electrical device according to claim 11, wherein said retaining rail is attached to said tank.

13. The electrical device according to claim 12, wherein said cover has track rollers supported in said retaining rail.

14. The electrical device according to claim 11, which further comprises a guide rail, said cover having guide rollers supported in said guide rail.

15. The electrical device according to claim 14, wherein said guide rail is disposed below said retaining rail.

16. The electrical device according to claim 15, which further comprises a pipeline of the electrical device, said guide rail being attached to said pipeline.

17. The electrical device according to claim 10, wherein said armor at least partially forms a wall of said tank.

18. The electrical device according to claim 10, wherein said armor is disposed at a distance from said tank.
